(19) United States
(12) Patent Application Publication
(10) Pub. No.: US 2024/0029253 A1
(43) Pub. Date: Jan. 25, 2024

(54) METHOD FOR ACQUIRING EVALUATION VALUE

(71) Applicant: FUJIFILM CORPORATION, Tokyo (JP)

(72) Inventors: Takeharu TANI, Kanagawa (JP); Ryusuke OSAKI, Kanagawa (JP)

(21) Appl. No.: 18/479,832

(22) Filed: Oct. 3, 2023

Related U.S. Application Data
(63) Continuation of application No. PCT/JP2022/014972, filed on Mar. 28, 2022.

(30) Foreign Application Priority Data
Apr. 21, 2021 (JP) 2021-072083

(51) Int. Cl. G06T 7/00; G06T 7/70; G06T 17/00; G01N 15/14; G03H 1/04; G03H 1/00

(52) U.S. Cl. CPC G06T 7/0012; G06T 7/70; G06T 17/00; G01N 15/1436; G03H 1/0443; G03H 1/0005; G06T 2207/30044; G01N 2015/1454; G01N 2015/0065

(57) ABSTRACT

Provided is a method for acquiring an evaluation value that can suppress an influence caused by an orientation of an object to be evaluated on an evaluation value derived based on a phase image of the object to be evaluated. The method for acquiring an evaluation value includes generating a phase image showing a phase distribution of light transmitted through an object, deriving an evaluation value of the object based on the phase image, and correcting the evaluation value by using a correction coefficient determined in accordance with an orientation of the object in the phase image.

### CROSS-REFERENCE TO RELATED APPLICATIONS

This application is a continuation application of International Application No. PCT/JP2022/014972, filed on Mar. 28, 2022, the disclosure of which is incorporated herein by reference in its entirety. Further, this application claims priority from Japanese Patent Application No. 2021-072083, filed on Apr. 21, 2021, the disclosure of which is incorporated herein by reference in its entirety.

### BACKGROUND

### 1. Technical Field

The disclosed technology relates to a method for acquiring an evaluation value for evaluating an object.

### 2. Description of the Related Art

The following technologies are known as technologies related to a cell evaluation method using a digital holography technology. For example, WO2019/176427A describes a determination method for generating a phase difference image of a cell from a hologram obtained by capturing the cells which are an aggregate of a plurality of cells and determining a state of a cell based on the phase difference image and a shape index value corresponding to a shape of the cell.

JP2012-531584A describes a method including a step of reconstructing phase and/or amplitude information of an object wave front from interference fringes formed by superimposing object light and reference light, and a step of measuring a parameter indicating quality of an embryo or an egg from the phase and/or amplitude information.

### SUMMARY

A phase image generated based on an interference image formed by interference between object light transmitted through a cell and reference light coherent to the object light is an image showing a phase distribution of the object light transmitted through the cell, and a state of the cell is reflected. Accordingly, quality of the cell can be evaluated based on the phase image. For example, a total phase amount obtained by integrating and accumulating phase amounts for pixels of the phase image can be used as an evaluation value of the cell.

However, it has been found that in a case where the cell is a non-spherical object, the total phase amount changes depending on an orientation (alignment angle) of the cell in the phase image. FIG. 1 is a graph representing an example of a relationship between a relative value of a total phase amount derived from a phase image of an embryonic cell in a two-cell stage and an orientation (alignment angle) of the embryonic cell in the phase image. It should be noted that, in the present specification, the alignment angle means an angle formed by a plane in which pixels of the phase image project and a direction in which two cells constituting the embryonic cell are arranged. FIG. 2 illustrates a visual line direction with respect to the embryonic cell in a case where the alignment angles are 0°, 45°, and 90°. From FIG. 1, it can be understood that the total phase amount changes in accordance with a change in the orientation (alignment angle) of the embryonic cell in the phase image.

Since the orientation (alignment angle) of the cell in the phase image is random, a variation in the total phase amount becomes large in a case where the total phase amount changes in accordance with the alignment angle. As a result, accuracy of the quality evaluation of the cell based on the total phase amount deteriorates. In a case where the total phase amount is used for the evaluation of the cell, it is preferable that the total phase amount derived for an identical cell is a constant value independent of the alignment angle.

The disclosed technology has been made in view of the above points, and an object thereof is to suppress an influence caused by an orientation of an object to be evaluated on an evaluation value derived based on a phase image of the object.

A method for acquiring an evaluation value according to the disclosed technology includes generating a phase image showing a phase distribution of light transmitted through an object, deriving an evaluation value of the object based on the phase image, and correcting the evaluation value by using a correction coefficient determined in accordance with an orientation of the object in the phase image.

The phase image may be generated based on an interference image formed by interference between object light transmitted through the object and reference light coherent to the object light. The evaluation value may be a total phase amount obtained by integrating and accumulating phase amounts for pixels of the phase image.

A virtual object simulating a shape, a dimension, and a refractive index of the object may be created based on the phase image, and the correction coefficient may be derived by using the virtual object. A virtual phase image showing a phase distribution of light transmitted through the virtual object may be generated, a virtual total phase amount obtained by integrating and accumulating phase amounts for pixels of the virtual phase image may be derived, a standard total phase amount obtained by multiplying a volume of the virtual object and a refractive index of the virtual object may be derived, and a ratio between the virtual total phase amount and the standard total phase amount may be derived as the correction coefficient.

The correction coefficient may be derived for each of cases where orientations of the virtual object are different, and a correction value of the evaluation value may be acquired by multiplying the evaluation value by the correction coefficient corresponding to the orientation of the object in the phase image used in a case where the evaluation value is derived.

The object may be a cell. The object may be an embryonic cell in a two-cell stage, and the virtual object may have a three-dimensional structure in which two ellipsoids are connected.

According to the disclosed technology, the influence caused by the orientation of the object to be evaluated on the evaluation value derived based on the phase image of the object can be suppressed.

### BRIEF DESCRIPTION OF THE DRAWINGS

Exemplary embodiments according to the technique of the present disclosure will be described in detail based on the following figures, wherein:

FIG. 1 is a graph representing an example of a relationship between a relative value of a total phase amount derived from a phase image of an embryonic cell and an orientation of the embryonic cell in the phase image;

FIG. 2 is a diagram illustrating a visual line direction with respect to the embryonic cell in the phase image in a case where alignment angles are 0°, 45°, and 90°;

FIG. 3 is a flowchart illustrating an example of a flow of a method for acquiring an evaluation value according to an embodiment of the disclosed technology;

FIG. 4 is a diagram illustrating an example of a configuration of a holography apparatus according to the embodiment of the disclosed technology;

FIG. 5 is a diagram illustrating an example of an interference image of an embryonic cell in a two-cell stage;

FIG. 6 is a diagram illustrating an example of a phase image of a cell generated based on the interference image illustrated in FIG. 5;

FIG. 7 is a diagram illustrating a concept of the phase image according to the embodiment of the disclosed technology;

FIG. 8 is a flowchart illustrating an example of a method for deriving a correction coefficient according to the embodiment of the disclosed technology;

FIG. 9 is a diagram illustrating an example of a phase image used in a case where a virtual object is created;

FIG. 10 is a diagram illustrating an example of a virtual phase image and an amplitude image generated for each of cases where an alignment angle of the virtual object is changed from 0° to 90° in 10° increments;

FIG. 11 is a graph representing an example of a correction coefficient for each alignment angle according to the embodiment of the disclosed technology;

FIG. 12 is a diagram illustrating an example of a result of specifying the alignment angle in the phase image of the embryonic cell;

FIG. 13A is a graph representing an example of a state of variation in a total phase amount before correction processing; and

FIG. 13B is a graph representing an example of a state of variation in the total phase amount after the correction processing.

### DETAILED DESCRIPTION

Hereinafter, an example of an embodiment of the disclosed technology will be described with reference to the drawings. It should be noted that, the same or equivalent components and portions in the drawings are assigned by the same reference numerals, and the overlapping description will be omitted.

A method for acquiring an evaluation value according to an embodiment of the disclosed technology includes generating a phase image showing a phase distribution of light transmitted through an object to be evaluated, deriving an evaluation value of the object based on the phase image, and correcting the evaluation value by using a correction coefficient determined in accordance with an orientation of the object in the phase image.

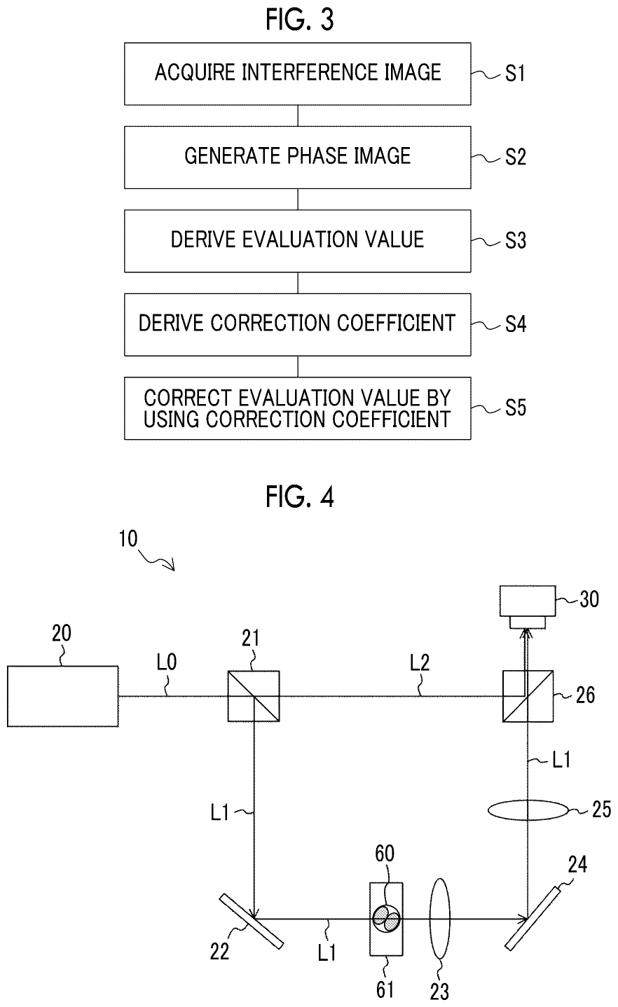

FIG. 3 is a flowchart illustrating an example of a flow of a method for acquiring an evaluation value according to the present embodiment. In step S1, an interference image (hologram) formed by interference between object light transmitted through an object to be evaluated and reference light coherent to the object light is acquired. In step S2, a phase image is generated based on the interference image acquired in step S1. In step S3, an evaluation value for evaluating a state of the object to be evaluated is derived based on the phase image generated in step S2. In step S4, correction coefficients for correcting the evaluation value are derived. In step S5, the evaluation value derived in step S3 is corrected by using the correction coefficients derived in step S4. Hereinafter, each of the above steps will be described in detail.

(Acquisition of Interference Image: Step S1)

A method for acquiring the interference image will be described below. FIG. 4 is a diagram illustrating an example of a configuration of a holography apparatus 10 for generating an interference image for the object to be evaluated. Hereinafter, a case where the object to be evaluated is an embryonic cell in a two-cell stage will be described as an example.

The holography apparatus 10 includes a splitter 21, reflection mirrors 22 and 24, an objective lens 23, an imaging lens 25, a combiner 26, and an imaging apparatus 30. A cell 60 to be evaluated is disposed between the reflection mirror 22 and the objective lens 23 in a state where the cell is accommodated in a container 61 together with a culture solution.

For example, a HeNe laser having a wavelength of 632.8 nm can be used as a laser light source 20. Laser light L0 which linearly polarized light emitted from the laser light source 20 is divided into two laser light rays by the splitter 21. One of the two laser light rays is object light L1 and the other is reference light L2. A beam splitter can be used as the splitter 21. The object light L1 is incident on the reflection mirror 22. The cells 60 are irradiated with the object light L1 of which a traveling direction is bent by the reflection mirror 22.

An image due to the object light L1 transmitted through the cells 60 is magnified by the objective lens 23. The object light L1 transmitted through the objective lens 23 is bent in the traveling direction by the reflection mirror 24 and is incident on the combiner 26 through the imaging lens 25. On the other hand, the reference light L2 is also incident on the combiner 26. The object light L1 and the reference light L2 are combined by the combiner 26 and are imaged on an imaging surface of the imaging apparatus 30. A beam splitter can be used as the combiner 26.

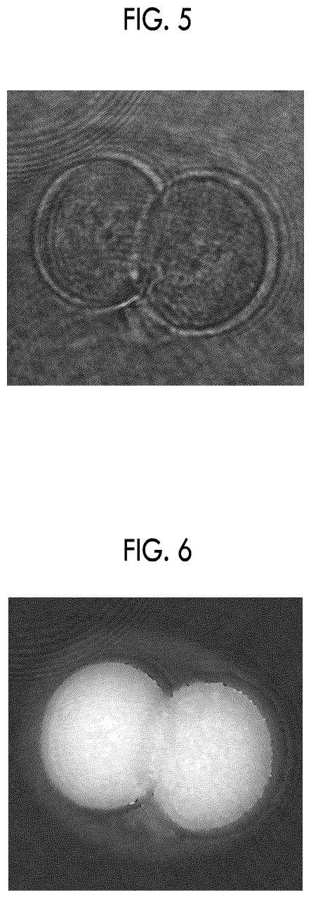

The interference image (hologram) generated by the interference between the object light L1 and the reference light L2 is imaged by the imaging apparatus 30. The imaging apparatus 30 comprises an imaging element such as a complementary metal-oxide-semiconductor (CMOS) image sensor, and generates image data of the interference image. FIG. 5 is a diagram illustrating an example of the interference image of the embryonic cell in the two-cell stage.

(Generation of Phase Image: Step S2)

An example of a method for acquiring the phase image from the interference image will be described below. First, an interference image (hologram) of the cell 60 acquired by the imaging apparatus 30 is trimmed to have a size of, for example, 2048×2048, and is then subjected to a two-dimensional Fourier transform. A Fourier-transformed image obtained by this processing may include an image based on direct light, object light, and conjugated light.

Subsequently, a position of the object light is specified by specifying a deviation amount of the object light with respect to the direct light in the Fourier-transformed image, and a complex amplitude component of only the object light is extracted by frequency filtering processing using a mask of a circular opening having a radius of 250 pixels.

Subsequently, for example, an angular spectrum method is applied to restore the image showing the phase of the cell 60 at any spatial position. Specifically, an angular spectrum U(fₓ, f_{y}; 0) of the Fourier-transformed image of a wave front u(x, y; 0) captured by the imaging surface of the imaging apparatus 30 is obtained. Subsequently, as represented in Equation (1) below, the angular spectrum U (fₓ, f_{y}; 0) is multiplied by a transfer function H(fₓ, f_{y}; z), and thus, a wave front at any position z in an optical axis direction (z direction) is reproduced. Here, the transfer function H(fₓ, f_{y}; z) is a frequency response function (Fourier transform of an impulse response function (green function)).

$$U ( {f}_{x} , {f}_{y} ; z ) = U ( {f}_{x} , {f}_{y} ; 0 ) H ( {f}_{x} , {f}_{y} ; z ) , H = {e}^{z \frac{2 π}{λ} \sqrt{1 - {( λ {f}_{x} )}^{2} - {( λ {f}_{y} )}^{2}}} \qquad ( 1 )$$

Subsequently, as represented in Equation (2) below, an inverse Fourier transform is performed on a wave front U(fₓ, f_{y}; z) at the position z in the optical axis direction (z direction), and thus, a solution u(x, y; z) at the position z is derived.

$$\begin{matrix}u ( x , y ; z ) = {F}^{- 1} [ U ( {f}_{x} , {f}_{y} ; z ) ] \\ = {F}^{- 1} [ U ( {f}_{x} , {f}_{y} ; 0 ) H ( {f}_{x} , {f}_{y} ; z ) ] \\ = {F}^{- 1} [ F [ u ( x , y ; 0 ) ] H ( {f}_{x} , {f}_{y} ; z ) ]\end{matrix} \qquad ( 2 )$$

Subsequently, the phase image is generated by deriving a phase y for u(x, y; z) as represented in Equation (3) below.

$$ϕ = arctan ( \frac{Im ( u )}{Re ( u )} ) \qquad ( 3 )$$

A phase in the phase image before unwrapping obtained by the above processing is wrapped to a value of 0 to 2π. Therefore, for example, portions of 2π or more are joined by applying a phase connection (unwrapping) method such as unweighted least squares or Flynn's algorithm, and thus, a final phase image can be obtained. It should be noted that, many unwrapping methods have been proposed, and an appropriate method that does not cause phase mismatch may be appropriately selected. FIG. 6 is a diagram illustrating an example of the phase image of the cell 60 generated based on the interference image illustrated in FIG. 5.

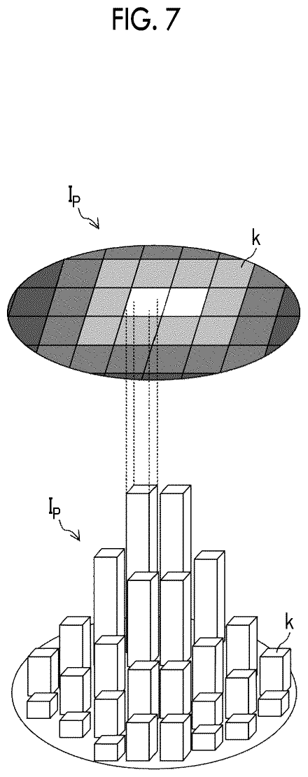

FIG. 7 is a diagram illustrating a concept of a phase image I_{P}. In a lower part of FIG. 7, a phase amount at each pixel k of the phase image I_{P} is three-dimensionally displayed. In an upper part of FIG. 7, the phase amount at each pixel k of the phase image I_{P} is illustrated on a plane in gray scale.

Here, in a case where a phase of a background (region where the cell 60 is not present) present in the same focal plane of the phase image I_{P} is P_{B} and a phase of a region where the cell 60 is present is P_{S}, a phase amount P in the phase image I_{P} is represented by Equation (4) below. In addition, the term “phase” in the present specification is a phase of an electric field amplitude in a case where light is regarded as an electromagnetic wave, and is used in a more general sense.

P=P_{S}−P_{B} (4)

In addition, a phase amount Pₖ at each pixel k of the phase image I_{P} can be represented by Equation (5) below. Here, nₖ is a difference between a refractive index of the cell 60 at a portion corresponding to each pixel k of the phase image I_{P} and a refractive index of the surroundings of the cell, dₖ is a thickness of the cell 60 at the portion corresponding to each pixel k of the phase image I_{P}, and λ, is a wavelength of the object light in a hologram optical system.

$${P}_{k} = 2 π \frac{{n}_{k} \cdot {d}_{k}}{λ} \qquad ( 5 )$$

(Derivation of Evaluation Value: Step S3)

The phase image of the cell 60 is an image showing a phase distribution of the object light L1 transmitted through the cell 60, and is also an image showing an optical path length distribution of the object light transmitted through the cell 60. Since an optical path length in the cell 60 corresponds to a product of a difference in the refractive index between the cell 60 and the surroundings of the cell the thickness of the cell 60, the phase image of the cell 60 includes information on the refractive index and the thickness (shape) of the cell 60 as represented in Equation (5). Since the state of the cell 60 is reflected in the phase image of the cell 60, the quality of the cell 60 based on the phase image can be evaluated. Specifically, a total phase amount P_{A} can be used as the evaluation value of the cell 60.

The total phase amount P_{A} is represented by Equation (6) below. Here, s is an area of each pixel k of the phase image, and vₖ is a volume of the cell 60 at the portion corresponding to each pixel k of the phase image. As represented in Equation (6), the total phase amount P A corresponds to an amount obtained by integrating and accumulating the phase amounts Pₖ for the pixels of the phase image of the cell 60 for all the pixels k. The pixel value of the phase image corresponds to the phase amount Pₖ.

$${P}_{A} = {\sum }_{k = 0}^{N} {P}_{k} \cdot s = \frac{2 π}{λ} {\sum }_{k = 0}^{N} {n}_{k} \cdot {d}_{k} \cdot s = \frac{2 π}{λ} {\sum }_{k = 0}^{N} {n}_{k} \cdot {v}_{k} \qquad ( 6 )$$

(Deviation of Correction Coefficient: Step S4)

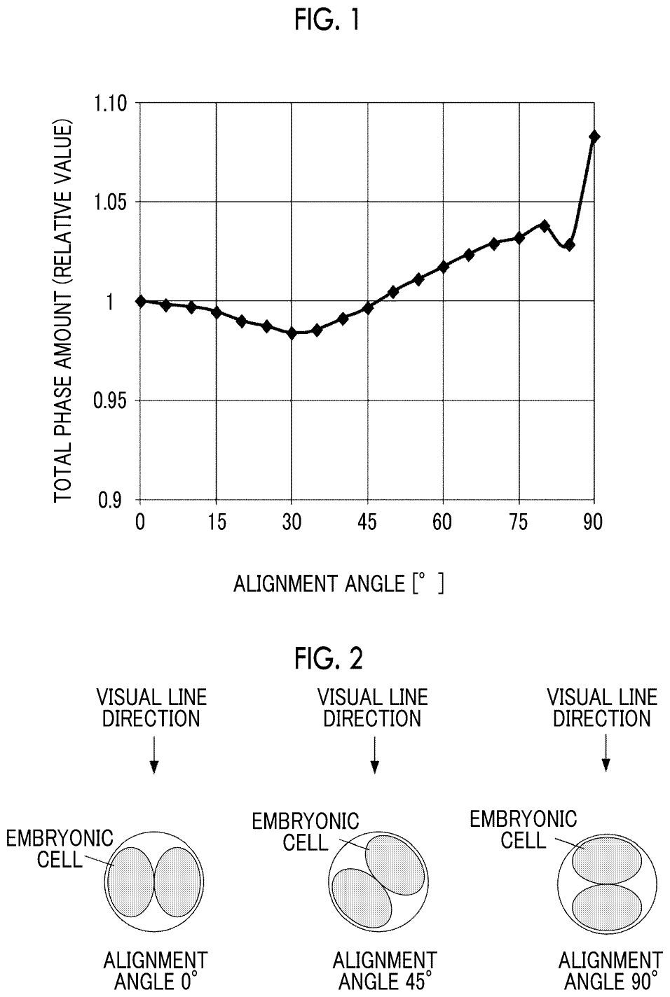

As illustrated in FIG. 1, the total phase amount P_{A} changes depending on an orientation (alignment angle) of the cell 60 in the phase image. The orientation (alignment angle) of the cell 60 in the phase image corresponds to an orientation (alignment angle) of the cell 60 with respect to an optical axis of the object light L1. It is preferable that the total phase amount P_{A} derived for the same cell 60 is a constant value independent of the alignment angle. The method for acquiring an evaluation value according to the present embodiment includes correcting the total phase amount P_{A} as the evaluation value by using correction coefficients determined in accordance with the orientation (alignment angle) of the cell 60 in the phase image. An example of the method for deriving the correction coefficient will be described below.

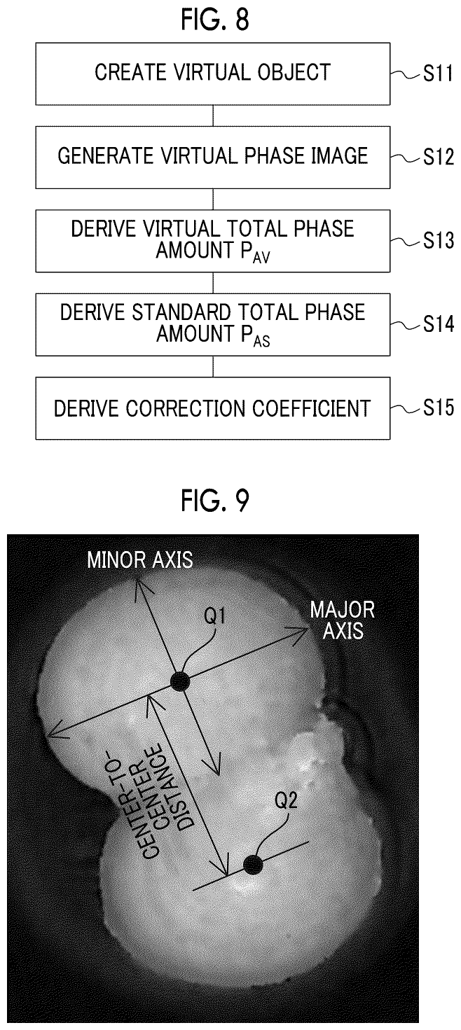

FIG. 8 is a flowchart illustrating an example of the method of deriving the correction coefficient. In step S11, a virtual object which is a three-dimensional model simulating a shape, dimensions, and refractive index of the object to be evaluated is created based on the phase image generated in step S2. Specifically, as illustrated in FIG. 9, a virtual object having a three-dimensional structure in which each of two cells constituting the embryonic cell, which is the object to be evaluated, included in the phase image is regarded as an ellipsoid and two ellipsoids are connected in a minor axis direction is created. A major axis, a minor axis, a center-to-center distance, and a refractive index n of the ellipsoid are measured from the phase image, and these pieces of information are applied to the virtual object. The refractive index n is a difference in refractive index with respect to a background (culture solution) and is represented by Equation (7). In Equation (7), P_{Q1} is a phase amount (pixel value) at a point Q1 of the phase image, and D_{L} is a thickness at the point Q1, that is, the major axis of the ellipsoid. The refractive index of the virtual object is uniform over the entire range.

n=P_{Q1}/D_{L} (7)

In step S12, a virtual phase image showing a phase distribution of light transmitted through the virtual object created in step S11 is generated. Specifically, an interference image is generated for the virtual object by using a numerical calculation method for calculating optical propagation, such as a finite-difference time-domain method (FDTD method). That is, the interference image of the virtual object is generated on a computer. Thereafter, the phase image is generated by performing the same processing as in step S2 on the interference image of the virtual object generated on the computer. The phase image generated for the virtual object is referred to as a virtual phase image in the present specification. It should be noted that, it is preferable that a focus position in a case where the virtual phase image is generated is determined by the same method as in a case where a focus position is determined in a case where the phase image is generated for the object to be evaluated. For example, a position where a variance of an amplitude image that can be generated from the interference image is minimized can be determined as the focus position.

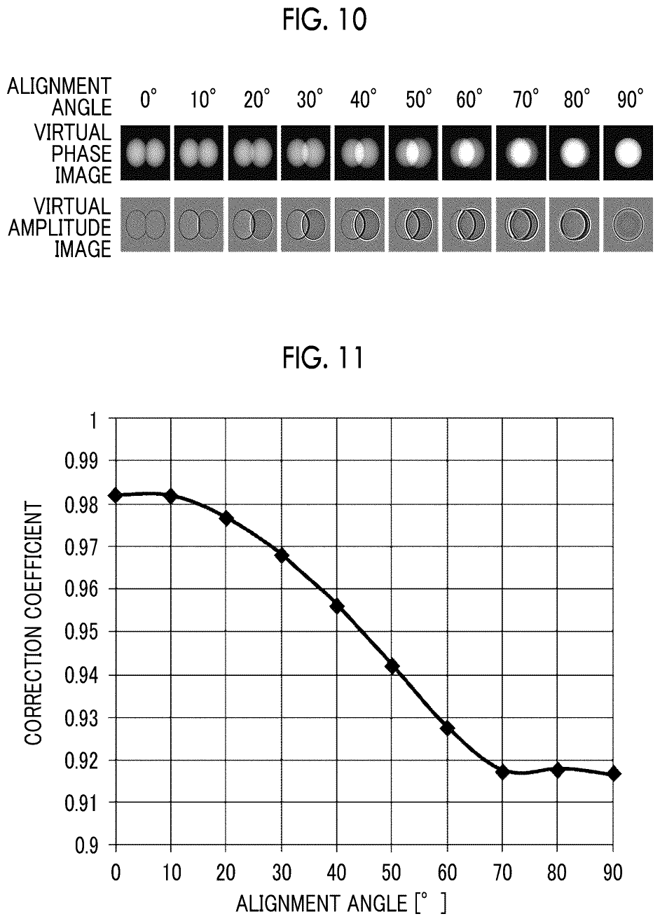

The virtual phase image is generated for each of cases where an orientation (alignment angle) of the virtual object is changed. FIG. 10 is a diagram illustrating an example of a virtual phase image and a virtual amplitude image generated for each of cases where the orientation (alignment angle) of the virtual object is changed from 0° to 90° in 10° increments.

In step S13, a total phase amount is derived by performing the same processing as in step S3 on the virtual phase image generated in step S12. That is, the total phase amount is derived by applying Equation (6) to the virtual phase image. The total phase amount derived for the virtual phase image is referred to as a virtual total phase amount P_{AV} in the present specification. The virtual total phase amount P_{AV} is derived for each of the cases where the orientation (alignment angle) of the virtual object is changed.

In step S14, a standard total phase amount P_{AS} is derived for the virtual object. The standard total phase amount P_{AS} is a standard value of the total phase amount in the virtual object and is represented by Equation (8) below. In Equation (8), n is a difference in refractive index between the virtual object and the surroundings, and V is a volume of the virtual object. The standard total phase amount P_{AS} is constant regardless of the orientation (alignment angle) of the virtual object.

P_{AS}=n×V (8)

In step S15, a ratio of the virtual total phase amount P_{AV} derived in step S13 to the standard total phase amount P_{AS} derived in step S14 is derived as a correction coefficient C. That is, the correction coefficient C is expressed by Equation (9) below. The correction coefficient C is derived for each of the cases where the orientation (alignment angle) of the virtual object is changed by using the virtual total phase amount P_{AV} derived for each of the cases where the orientation (alignment angle) of the virtual object is changed.

C=P_{AS}/P_{AV} (9)

FIG. 11 is a graph representing an example of the correction coefficient for each alignment angle derived by performing the above each processing.

(Correction of Evaluation Value: Step S5)

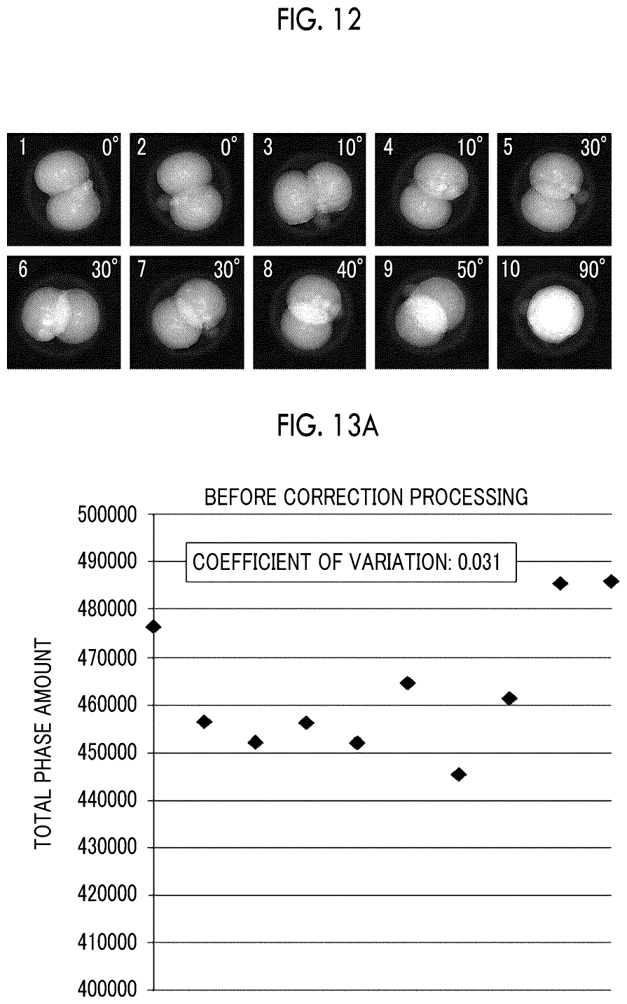

The total phase amount P_{A} as the evaluation value derived in step S3 is corrected by using the correction coefficients C derived in step S4. Specifically, the orientation (alignment angle) of the object to be evaluated is specified in the phase image used in a case where the total phase amount P_{A} is derived for the object. FIG. 12 is a diagram illustrating an example of a result of specifying the orientation (alignment angle) of the embryonic cell in the phase image. It should be noted that, the orientation (alignment angle) of the object may be specified visually or may be specified by using a known image recognition technology.

Subsequently, the correction coefficient C corresponding to the specified orientation (alignment angle) of the object is extracted from among the correction coefficients C derived in step S4. Then, a correction value P_{X} is acquired by multiplying the extracted correction coefficient C by the total phase amount P_{A} as the evaluation value derived in step S3. That is, the correction value of the total phase amount P_{A} is expressed by Equation (10) below.

P_{X}=C×P_{A} (10)

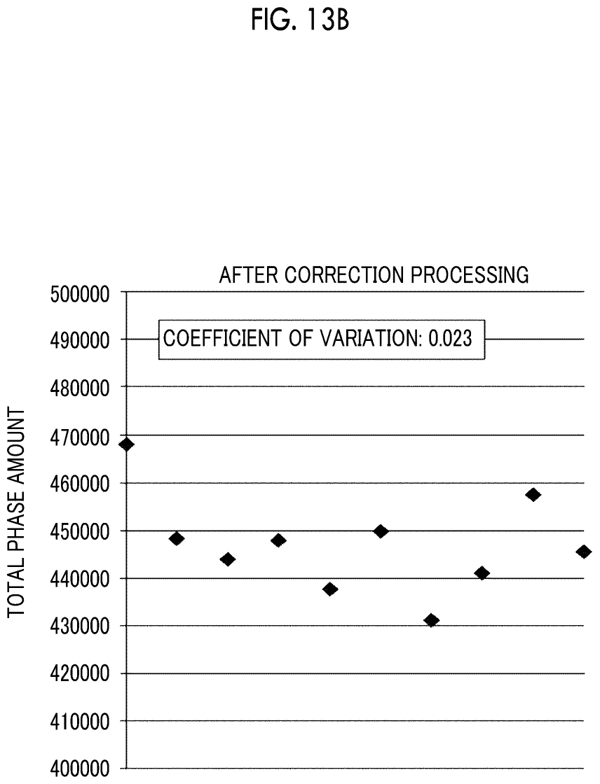

FIG. 13A and FIG. 13B are graphs representing examples of a state of a variation of the total phase amount derived based on the phase image of the same embryonic cell, respectively, FIG. 13A is a graph before correction processing, and FIG. 13B is a graph after the correction processing. It should be noted that, each plot in the graph is derived based on each of the phase images illustrated in FIG. 12. As is clear from a comparison between FIGS. 13A and 13B, the variation in the total phase amount was reduced by performing the correction processing. Specifically, a coefficient of variation of the total phase amount after the correction processing was 0.031, whereas a coefficient of variation of the total phase amount after the correction processing was 0.023.

As described above, according to the method for acquiring an evaluation value according to the disclosed technology, an influence caused by the orientation of the object on the evaluation value derived based on the phase image of the object to be evaluated can be suppressed. Accordingly, the evaluation value can be stably acquired, and the variation in the evaluation value can be suppressed.

It should be noted that, in the present embodiment, a case where the evaluation target is the cell has been illustrated, but the disclosed technology is not limited to this aspect. The disclosed technology is not limited to the cell, and any object including an industrial product having transparency to the object light can be evaluated. The disclosed technology is particularly effective in a case where the shape of the object to be evaluated is a non-spherical object. In addition, in the present embodiment, the total phase amount has been described as the evaluation value for evaluating the state of the object, but the disposed technology is not limited to this aspect. For example, a phase density obtained by dividing the total phase amount by the volume of the object, an average phase amount which is an average value of pixel values in the phase image, a maximum phase amount which is a maximum value of the pixel value in the phase image, a variance of the pixel values in the phase image, and the like can also be used as the evaluation value.

It should be noted that, the disclosure of Japanese Patent Application No. 2021-072083 filed on Apr. 21, 2021 is incorporated herein by reference in its entirety. In addition, all documents, patent applications, and technical standards described in the specification are incorporated herein by references to the same extent as the incorporation of the individual documents, patent applications, and technical standards by references are described specifically and individually.

What is claimed is:

1. A method for acquiring an evaluation value, comprising:
generating a phase image showing a phase distribution of light transmitted through an object;
deriving an evaluation value of the object based on the phase image; and
correcting the evaluation value by using a correction coefficient determined in accordance with an orientation of the object in the phase image.

2. The method for acquiring an evaluation value according to claim 1,
wherein the phase image is generated based on an interference image formed by interference between object light transmitted through the object and reference light coherent to the object light.

3. The method for acquiring an evaluation value according to claim 1,
wherein the evaluation value is a total phase amount obtained by integrating and accumulating phase amounts for pixels of the phase image.

4. The method for acquiring an evaluation value according to claim 1,
wherein a virtual object simulating a shape, a dimension, and a refractive index of the object is created based on the phase image, and the correction coefficient is derived by using the virtual object.

5. The method for acquiring an evaluation value according to claim 4,
wherein a virtual phase image showing a phase distribution of light transmitted through the virtual object is generated,
a virtual total phase amount obtained by integrating and accumulating phase amounts for pixels of the virtual phase image is derived,
a standard total phase amount obtained by multiplying a volume of the virtual object and a refractive index of the virtual object is derived, and
a ratio between the virtual total phase amount and the standard total phase amount is derived as the correction coefficient.

6. The method for acquiring an evaluation value according to claim 4,
wherein the correction coefficient for each of cases where orientations of the virtual object are different is derived, and
a correction value of the evaluation value is acquired by multiplying the evaluation value by the correction coefficient corresponding to the orientation of the object in the phase image used in a case where the evaluation value is derived.

7. The method for acquiring an evaluation value according to claim 1,
wherein the object is a cell.

8. The method for acquiring an evaluation value according to claim 4,
wherein the object is an embryonic cell in a two-cell stage, and
the virtual object has a three-dimensional structure in which two ellipsoids are connected.
